(19) United States
(12) Patent Application Publication
(10) Pub. No.: US 2026/0187455 A1
(43) Pub. Date: Jul. 2, 2026

(54) ADAPTIVE MULTI EXPERT ROUTING FOR TASK AND TENANT SPECIFIC EXPERT MODELS

(71) Applicant: BMC Helix, Inc., Houston, TX (US)

(72) Inventors: Sai Eswar Garapati, San Jose, CA (US); Erhan Giral, Danville, CA (US); Christopher Joel Holdbrooks, Friant, CA (US)

(21) Appl. No.: 19/096,282

(22) Filed: Mar. 31, 2025

Related U.S. Application Data
(60) Provisional application No. 63/740,015, filed on Dec. 30, 2024.

(51) Int. Cl. G06N 3/082; G06N 3/048

(52) U.S. Cl. CPC G06N 3/082; G06N 3/048

(57) ABSTRACT

In described systems and techniques an input vector is received. A first similarity metric between the input vector and a first routing vector associated with a first model is determined, and a second similarity metric between the input vector and a second routing vector associated with a second model is determined. The input vector is routed to the first model, based on the first similarity metric and the second similarity metric.

### CROSS-REFERENCE TO RELATED APPLICATION

This application claims benefit, under 35 U.S.C. § 119, of U.S. Provisional Patent Application No. 63/740,015, filed on Dec. 30, 2024, entitled “ADAPTIVE MULTI EXPERT FOR TASK AND TENANT SPECIFIC ADAPTERS FOR IT PROBLEM ANALYSIS, EXPLANATION, AND REMEDIATION,” the disclosure of which is incorporated by reference herein in its entirety.

### TECHNICAL FIELD

This description relates to network event management.

### BACKGROUND

Many companies and other entities have extensive technology landscapes that include numerous Information Technology (IT) assets, including hardware and software. It is often required for such assets to perform at high levels of speed and reliability, while still operating in an efficient manner. For example, various types of computer systems are used by many entities to execute business-critical applications and high volumes of data processing, across many different workstations and peripherals.

Various types of system monitoring methods are used to detect, predict, prevent, mitigate, or cure system faults that might otherwise disrupt or prevent monitored IT assets from achieving system goals. For example, it is possible to monitor various types of performance metrics characterizing aspects of system performance. When monitored values of the detected performance metrics exceed a predetermined threshold, the monitored values may be considered potentially indicative of a current or future system malfunction, and responsive action may be taken.

In other examples, log records may be captured over time to be able to identify, track, diagnose, and repair malfunctions, or to optimize the efficiency or reliability of underlying components or systems. In still other examples, manual and/or automated help desks may be maintained to provide assistance to users who experience difficulties within a given technology landscape.

Trained machine learning (ML) models may be used to support the above and other aspects of maintaining resources within a technology landscape. In particular, specialized or expert models may be configured to process individual ones of, e.g., the types of IT data referenced above. However, as new data is received, it may be difficult to determine which of the expert models should be used.

### SUMMARY

According to one general aspect, a computer program product may be tangibly embodied on a non-transitory computer-readable storage medium and may comprise instructions. The instructions, when executed by at least one computing device, may be configured to cause the at least one computing device to receive an input vector, determine a first similarity metric between the input vector and a first routing vector associated with a first model, and determine a second similarity metric between the input vector and a second routing vector associated with a second model. The instructions, when executed by the at least one computing device, may be configured to cause the at least one computing device to route the input vector to the first model, based on the first similarity metric and the second similarity metric.

According to other general aspects, computer-implemented methods may perform the instructions of the computer program products. According to other general aspects, a system, such as a distributed server system, may include at least one memory, including instructions, and at least one processor that is operably coupled to the at least one memory and that is arranged and configured to execute instructions that, when executed, cause the at least one processor to perform the instructions of the computer program products and/or the operations of the computer-implemented methods.

The details of one or more implementations are set forth in the accompa-nying drawings and the description below. Other features will be apparent from the description and drawings, and from the claims.

### BRIEF DESCRIPTION OF THE DRAWINGS

FIG. 1 is a block diagram of a system for adaptive multi-expert routing for task and tenant-specific expert models.

FIG. 2 is a flowchart illustrating example operations of the system of FIG. 1.

FIG. 3 is a block diagram illustrating a more detailed example of the system of FIG. 1.

FIG. 4 is a block diagram illustrating the example of FIG. 3, with tenant-specific routing.

FIG. 5 illustrates example routing in the system of FIGS. 3 and 4.

FIG. 6A is a flowchart illustrating example operations for receipt and preparation of training data.

FIG. 6B is a flowchart example training operations using the prepared training data of FIG. 6A.

FIG. 6C is a flowchart illustrating example inference and routing operations.

FIG. 6D is a flowchart illustrating example routing operations for the inference operations of FIG. 6C.

FIG. 7 is an example transformer layer that may be used to implement the systems of FIGS. 1 and 3.

FIG. 8 is an example of a more detailed view of the example transformer layer of FIG. 7.

FIG. 9 is a more detailed example of a low rank adapter of FIG. 8.

FIG. 10 is a block diagram of an example multi-head attention layer of the example transformer layer of FIG. 7.

### DETAILED DESCRIPTION

Sustaining the stability and reliability of large-scale networks has been an important need in the IT management area. It is challenging, however, to provide such stability and reliability in a practical IT environment(s), due to the dynamic, ever-growing, and distributed nature of large-scale enterprise networks. Effective management of such environments typically requires an in-depth understanding of multiple domains within a business to communicate and resolve the problem(s). Moreover, such environments may also vary from one business to another.

Effective analysis, explanation, and remediation of IT problems using large language models are significant for high-availability systems. However, inference based solely on textual data from events limits an ability to grasp the overall context, which is distributed across several devices over multiple domain topologies, including logs, metrics, traces, tickets, and incidents.

Described techniques provide a multi-expert routing system with task- and tenant-specific expert models (e.g., adaptors) that do not require manual routing but are adaptive based on data, using automatic gating. This approach enables best-available reasoning for root cause, impact, explanation, and remediation from numerous sources in various domains. Consequently, IT teams may focus their efforts on resolving an underlying issue comprehensively, leveraging data from various domains, rather than addressing symptoms, and thereby leading to more efficient and effective problem resolution.

For example, within a single business, e.g., a single company, multiple domains within an IT environment of the business may include, without limitation, network operations (e.g., anomaly detection), human resources data management, incident/ticket management, Internet of Things (IoT) monitoring, or network log management, among others. Within a single business, many differences will exist between these domains in terms of, e.g., terminologies, typical problems/solutions, and required resources. Among multiple businesses, each business may have the same or overlapping domains, yet may have many additional differences between corresponding domains (e.g., between human resources domains of two different businesses), due to the natures of the businesses involved.

A provider of network management software and related services may seek to provide support across all such domains for many different types of businesses. For example, such a provider may provide trained large language models (LLMs) and other machine learning (ML) techniques to process various types of inputs and provide corresponding outputs.

Such inputs (and corresponding outputs) may vary based on corresponding differences in the types of domains referenced above, as well as on the types of differences among separate businesses that are also referenced above. For example, in the context of incident/ticket management (e.g., help desk environments), inputs may include textual descriptions of problems experienced by users, while outputs may include descriptions of solutions provided in response. In the context of log management, inputs may include time-stamped log records having a well-defined format, while outputs may include analysis results of a set of log records that identify, e.g., a source of a problem or an area for optimization. In the context of network management, inputs may include directed graphs in which network components are provided as nodes connected by known or determined relationships, while outputs may include knowledge determined from such graphs, such as a source node of a detected anomaly.

As referenced above, LLMs and other machine learning techniques may be used to provide, automate, or facilitate many useful aspects of IT network management. For example, a LLM may input an incident ticket with lengthy textual portions describing the problem that the user is experiencing with his or her computer system, a history of a corresponding problem that was already resolved and output a summary of the relevant portions of the problem and resolution. In other examples, a LLM may input a description of a network anomaly and output a potential solution for resolving the anomaly.

LLMs, however, typically require very large quantities of computing resources, can be difficult to train and deploy, and are therefore expensive to implement. For example, a LLM may utilize billions of weights and other parameters, and may require specialized processors (e.g., graphical processor units, or GPUs) and associated specialized memories (e.g., GPU memories).

It is possible to pre-train such models for general language processing, and then fine-tune the pre-trained models for more specific environments, such as IT management. However, such approaches are still impractical for deploying LLMs among the many different domains referenced above, much less among the different versions of such domains that exist between different businesses. Moreover, it is not practical to repeat the training and/or fine-tuning process(es) frequently enough to keep up with changes within the underlying IT environments. As a result, attempts to use conventional approaches to training and deploying LLMs and other ML models in the context of IT management result in LLMs that provide, at best, overly generic outputs and/or solutions that are prone to becoming obsolete.

Described techniques, in contrast, use the above-referenced types of LLMs as a foundation or primary model(s), while using multiple smaller models, referred to herein as expert models, to facilitate specialized and highly customized processing of IT data. For example, such expert models may be incrementally trained over time, using training techniques that are fast and accurate, but that are infeasible for use in training the larger, underlying model. Then, multiple ones of such expert models may be deployed, so that an appropriate one of such expert models may be selected and deployed in combination with the underlying primary model to process a corresponding type of IT data.

For example, a primary LLM or other model may be trained, using conventional techniques, to process all sorts of IT data. Then, a first expert model may be trained for use in the example context of incident tickets and/or help desk contexts, while a second expert model may be trained for use in the example context of log record management. Incoming requests may be routed for processing by either the first expert model or the second expert model, and either expert model may be implemented in the context of the primary model, depending on which request is currently being processed.

During deployment, the various expert models may be hot swapped with one another within the primary model as needed to respond to corresponding requests. For example, in the examples above, the help desk expert model may be used in conjunction with the primary model to process help desk data, while the log record expert model may be used in conjunction with the primary model to process log record data.

However, even if a plurality of such expert models are successfully constructed and deployed, it may be difficult to determine which of the expert models should be used to process a given input that has been received. Put another way, it may be difficult to determine one or more expert models of a pool or set of expert models that is/are most capable of processing a received input.

Further, such difficulties in selecting an expert model for use in processing a received input may be exacerbated by some of the qualities referenced above that make the expert models useful and desirable. For example, as discussed, many different types of expert models may be constructed, which may be particular to not only the subject matter but also to the users (e.g., tenants) for whom the expert models are constructed. Moreover, expert models included in an available or deployed set of expert models may change rapidly, as some models are retired and/or new models are added.

It is possible to route incoming requests in a centralized manner, in which a routing mechanism considers, and is trained in conjunction with, all of a set of relevant expert models. Such approaches have the disadvantage of requiring knowledge and use of all of the expert models (and associated training data), which (in addition to being time-consuming and burdensome) is contrary to the assumption of specialized knowledge used in constructing each of the expert models in the first place. Moreover, even if such a centralized routing mechanism is constructed, changes to the corresponding collection of expert models may obviate the centralized routing mechanism and/or require retraining or other reconfiguration.

Described techniques decentralized approach to routing a received input (e.g., request or question) to a best-available expert model(s) for further processing. Described techniques do not require a comprehensive knowledge of, or access to, data including training data) relevant to all of the expert models. As a result, individual expert models may be added to, or removed from, an available pool or set of expert models on an as-needed or as-available basis. Moreover, a new expert model may be added to an available set of expert models using training data and related data of the new expert model itself, with minimal additional processing time and resources beyond those required to provide the new expert model itself.

Thus, described techniques solve the technical problem of routing received inputs to a best-available expert model(s) in a fast, reliable, and resource-efficient manner. Consequently, users may receive best-available responses from the expert models, even when many different types of inputs are provided to a number of different types of expert models.

Described techniques provide a technical solution that includes constructing a routing vector for each expert model, typically in conjunction with the training of the expert model itself. That is, the routing vector for an expert model may be constructed (e.g., parameterized) using at least some of the same training data used to train the corresponding expert model, and without requiring knowledge of other training data and/or other expert models.

In this way, a set of expert models is associated with a corresponding set of routing vectors. When an input is received, the input may be converted to an input vector, and a similarity analysis between the input vector and each of the routing vectors may be performed. Then, for example, the input may be routed to the expert model having the highest degree of similarity between its corresponding routing vector and the input vector. In other examples, a combination of expert models may be selected to process the input vector. Accordingly, users may submit queries and receive best-available responses, without being required to know which expert models are available and/or which expert model(s) is best-suited to process each submitted query.

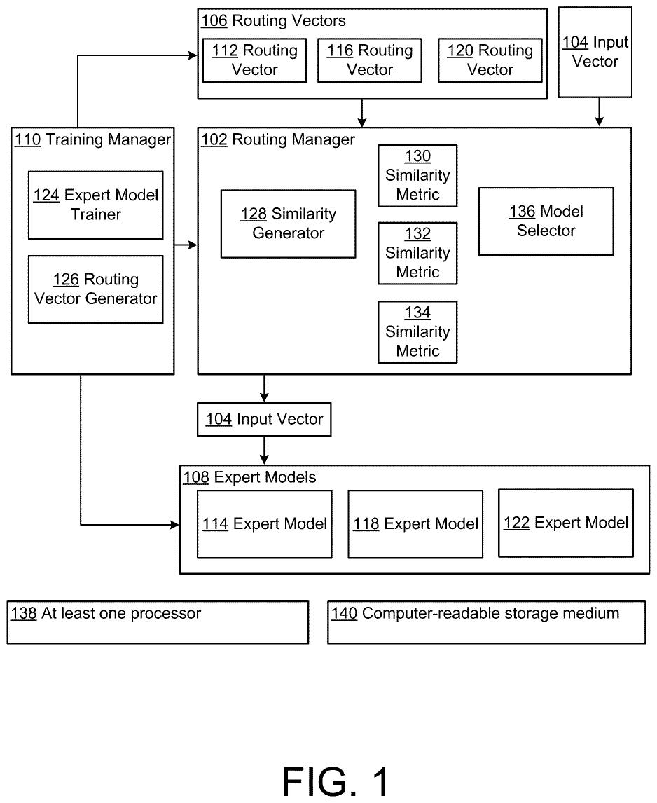

FIG. 1 is a block diagram of a system for adaptive multi-expert routing for task and tenant-specific expert models. In the example of FIG. 1, a routing manager 102 is configured to process an input vector 104 and each of a plurality of routing vectors 106, where each routing vector of the routing vectors 106 corresponds to one of a plurality of available expert models 108. Based on obtained comparison results, the routing manager 102 may then route the input vector 104 to a selected one(s) of the plurality of expert models 108, for processing thereby.

In more detail, a training manager 110 may be configured to train or otherwise parameterize the routing vectors 106 and the expert models 108. More specifically, and as referenced above, the routing vectors 106 may include a routing vector for each expert model of the expert models 108. Thus, in the simplified example of FIG. 1, a routing vector 112 corresponds to an expert model 114, a routing vector 116 corresponds to an expert model 118, and a routing vector 120 corresponds to an expert model 122.

More specifically, the training manager 110 may be configured to train or otherwise parameterize each routing vector/expert model pair in conjunction with one another, and using the same training data (or a subset thereof). For example, as shown, the training manager 110 may include an expert model trainer 124 and a routing vector generator 126. Thus, when constructing an expert model of the expert models 108, a corresponding routing vector may be generated, and no knowledge of remaining or separate expert models/routing vectors is required to do so.

For example, in a first or initialization phase of the system of FIG. 1, when no expert models have yet been provided, the training manager 110 may be used to train the expert model 114. The expert model 114 may be any type of expert model, so that the expert model trainer 124 may be configured to provide any suitable and corresponding type of model training, some examples of which are provided below. Moreover, the expert model 114 may have any available area of expertise. For example, in the types of IT management environments referenced above, the expert model 114 may be configured to provide log record analysis.

As referenced above, the expert model trainer 124 may be used, together with a set of training data (not shown separately in FIG. 1), to train the expert model 114. For example, the relevant training data may include a large set of log records and associated analysis results. As also referenced above, the expert model 114 may be built on top of, and used in conjunction with, an underlying, general purpose LLM, which is also not shown separately in FIG. 1. However, any type of expert or specialized model may be used.

In conjunction with training the expert model 114, the same training data may be used by the routing vector generator 126 to parameterize a routing vector that corresponds to the expert model 114. For example, the routing vector 112 may be parameterized by the routing vector generator 126, using a subset of the training data used to train the expert model 114, and thus parameterizing the routing vector 112 with respect to, in the example, log record analysis.

For example, a first user of the system of FIG. 1 may be tasked with generating the expert model 114. The first user may have subject matter expertise in log record analysis, and/or may have access to relevant training data for log record analysis. The first user may utilize a first instance of the training manager 110 to provide the expert model 114 and the routing vector 112.

Meanwhile, a second user may be tasked with generating the expert model 118, which may be configured for, e.g., help desk/incident management tasks. Again, the second user may have subject matter expertise in relevant areas, and/or may have access to relevant training data. The second user may utilize a second instance of the training manager 110 to provide the expert model 118 and the routing vector 116. As described herein, neither the first user nor the second user is required to have knowledge of the other's activities or subject matter expertise. Instead, each user may work independently, and may simply deploy resulting routing vectors/expert models for access by the routing manager 102.

Within the routing manager 102, during runtime or inference time, when the input vector 104 is received, a similarity generator 128 may be configured to process or otherwise characterize a degree of similarity between the input vector 104 and each of the routing vectors 112, 114. For example, a similarity metric 130 may represent such a similarity characterization between the input vector 104 and the routing vector 112 (corresponding to the expert model 104), while a similarity characterization between the input vector 104 and the routing vector 116 (corresponding to the expert model 118).

Then, a model selector 136 may be configured to process the similarity metrics 130, 132 to select between the expert models 114, 118. For example, the similarity generator 128 may generate a normalized value, e.g., between 0 and 1, characterizing a degree of similarity between the input vector 104 and each of the routing vectors 112, 116.

Then, the model selector 136 may be configured to select one of the expert models 114, 118, based on the similarity metrics 130, 132. Assuming for the sake of the example that the similarity metric 130 between the input vector 112 and the expert model 114 is chosen, the routing manager 102 may then forward the input vector 104 to the expert model 114 for processing.

At a later time, a third user may be tasked with generating the expert model 122, which may be configured for, e.g., root cause analysis tasks for identifying root cause events that resulted in system anomalies. The third user may have subject matter expertise in relevant areas, and/or may have access to relevant training data. The third user may utilize a third instance of the training manager 110 to provide the expert model 122 and the routing vector 120.

Then, the expert model 122 and the routing vector 120 may simply be deployed to the pools of the routing vectors 106 and the expert models 108. The third user is not required to have any knowledge of existing contents of those pools; e.g., may not know that the expert models 114, 118 have already been deployed. Moreover, neither the third user, nor any other user, is required to make any modifications to the routing manager 102 to deploy the routing vector 120 and the expert model 122.

If the input vector 104 is received at a time when all three of the expert models 114, 118, 122 are deployed, then the similarity generator 128 may generate the similarity metrics 130, 132 as described, and may also generate a similarity metric 134 characterizing a degree of similarity between the input vector 104 and the routing vector 120. Consequently, in this example, the model selector 136 may analyze all three of the similarity metrics 130, 132, 134 to select a best-available one of the expert models 114, 118, 122. In other words, the similarity metrics 130, 132, 134 may be thought of as providing a probability distribution characterizing a likelihood that each of the expert models 114, 118, 1122 would be best-suited for processing the input vector 104.

Conversely, it should be apparent from the above description that, at a still later time, any one of the expert models 114, 118, 122 (and its corresponding routing vector) may be removed from the expert models 108, and remaining expert models will continue to have input vectors routed correctly. Thus, more generally, it may be observed that the pool of expert models 108 may easily be updated over time to include/exclude specific expert models on an as-needed basis, without requiring other configuration updates beyond including/excluding corresponding routing vectors. For example, as referenced above, it is not necessary to update or reconfigure the routing manager 102, as the routing manager 102 may be configured to provide pairwise processing of a received input vector with each and all routing vectors of the routing vectors 106.

Therefore, the system of FIG. 1 may be quickly, easily, and efficiently deployed and maintained, with little or no downtime required for updating currently available expert models/routing vectors. Many different users may independently access and use the training manager 110 and the routing manager 102, so that such users may focus on their respective areas of subject matter expertise, without requiring a separate administrator or other user to update the routing manager 102.

The system of FIG. 1 may be deployed on-premise or as a service. For example, a single business entity may deploy the system of FIG. 1 on-premise to provide processing of the examples given above of log record analysis, help desk/incident ticket management, and root cause analysis. In other examples, the system of FIG. 1 may be deployed as a service and used to manage operations of multiple entities.

In the latter cases, or similar cases, the expert models 108 may easily be adapted to be specifically customized or optimized for each entity. For example, three different entities (e.g., tenants, not shown in FIG. 1) may access the system of FIG. 1 as a service. Then, the expert models 114, 118, 122 may each represent models trained for log record analysis, but with the log record analysis customized or optimized for specific types of log record analysis desired by each tenant. That is, the first tenant may desire certain types of log records or log record analysis that is not needed for log record analysis of a second tenant, and corresponding expert models may be trained accordingly.

As also shown, the system of FIG. 1 may be implemented using at least one processor 138 and at least one non-transitory computer-readable storage medium 140. For example, the at least one processor 138 may include or represent one or more central processing units (CPUs) and/or at least one graphical processing units (GPUs), while the computer-readable storage medium 140 may include or represent various types of associated primary or secondary memories. For example, the computer-readable storage medium 140 may be configured to store instructions that may be executed by the at least one processor 138 to provide the training manager 110 and the routing manager 102, and associated functionalities and operations thereof. In other examples, the computer-readable storage medium 140 may be used to store data, such as the routing vectors 106, the expert models 108, and any associated training data.

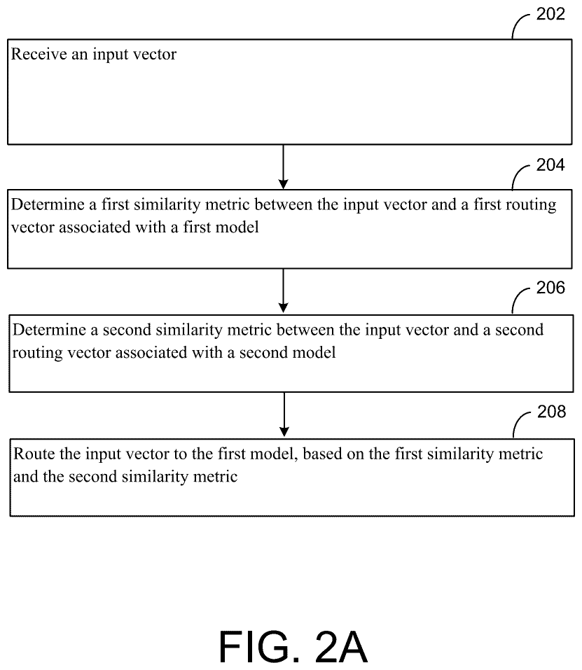

FIG. 2 is a flowchart illustrating example operations of the system of FIG. 1. In the example of FIG. 2, operations are illustrated as separate, sequential operations. In various implementations, the illustrated operations may include sub-operations, may be performed in a different order, may include alternative or additional operations, or may omit one or more operations. Further, in all such implementations, included operations may be performed in an iterative, looped, nested, or branched fashion.

In FIG. 2, an input vector may be received (202). For example, the routing manager 102 may be configured to receive the input vector 104. As noted above, and described in more detail, below, the input vector 104 may be constructed or converted from an earlier query, which may take one or more of multiple forms/formats. For example, a text-based query, graph-based query, or image-based query may be received and converted to an embedding space.

A first similarity metric may be determined between the input vector and a first routing vector associated with a first model (204). For example, the similarity generator 128 of the routing manager 102 may be configured to determine the similarity metric 130 between the routing vector 112, associated with the expert model 114, and the input vector 104.

A second similarity metric may be determined between the input vector and a second routing vector associated with a second model (206). For example, the similarity generator 128 of the routing manager 102 may be configured to determine the similarity metric 132 between the routing vector 116, associated with the expert model 118, and the input vector 104.

The input vector may be routed to the first model, based on the first similarity metric and the second similarity metric (208). For example, the model selector 136 may be configured to determine that the similarity metric 130 is greater than the similarity metric 132, or otherwise indicates greater similarity between the input vector 104 and the routing vector 112 (and thus the expert model 114) than between the input vector 104 and the routing vector 116 (and thus the expert model 118).

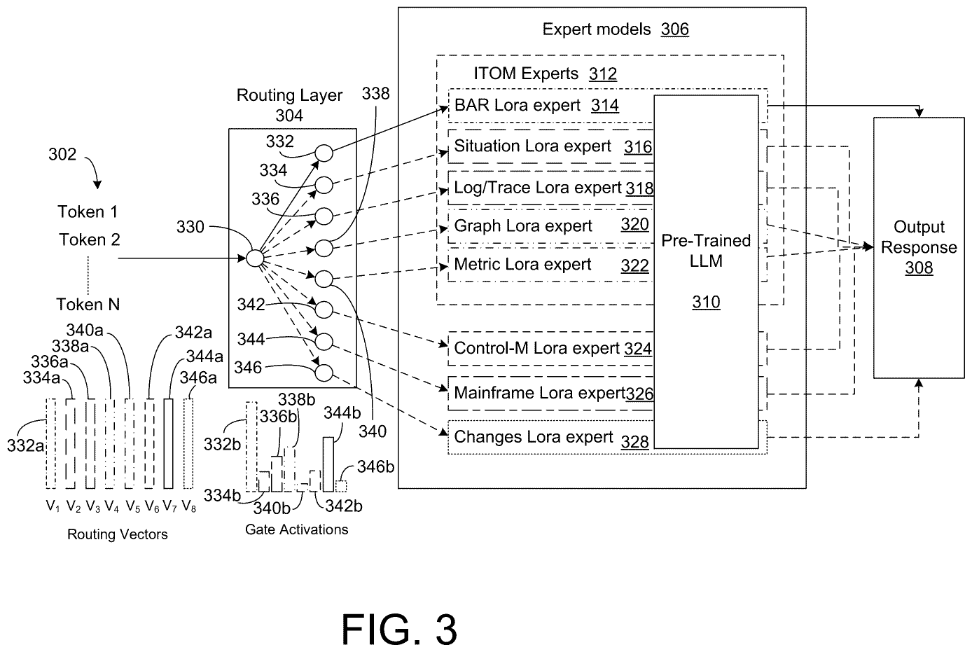

FIG. 3 is a block diagram illustrating a more detailed example of the system of FIG. 1. In the example of FIG. 3, input tokens 302 are received at a routing layer 304. The routing layer 304 is configured to route the input tokens 302, including obtaining an input vector therefore, as referenced above and described in more detail, below, to one or more expert models 306. The selected expert model(s) may process the input vector and provide a corresponding output response 308.

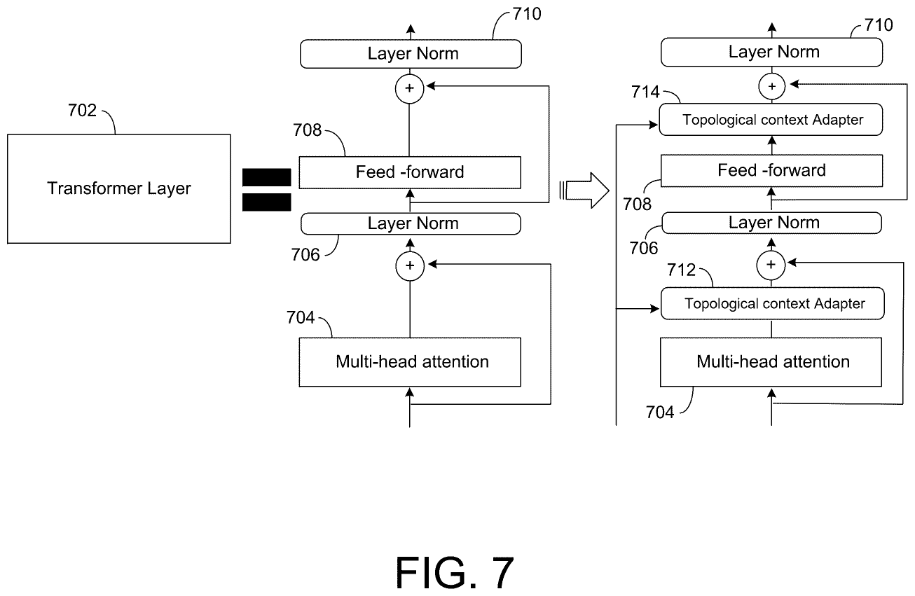

In FIG. 3, the various expert models are each formed in conjunction with an underlying pre-trained large language model (LLM) 310. For example, the various expert models 306 may be formed as, or using, low ranked adaptor (Lora) experts leveraging the pre-trained LLM 310, as described in more detail below with respect to FIGS. 7-10. In the example of FIG. 3, the expert models 306 include various Information Technology Operations Management (ITOM) experts 312, illustrated as a Business Activity Reporting (BAR) Lora expert 314, a situation Lora expert 316, a log/trace Lora expert 318, a graph Lora expert 320, and a metric Lora expert 322. Other expert models in FIG. 3 include a Control-M (for workload management) Lora expert 324, a mainframe Lora expert 326, and a changes Lora expert 328. It will be appreciated that the various illustrated experts are provided primarily to assist in illustrating and explaining operations of the routing layer 304, and are non-limiting, so that various additional or alternative expert models may be used, as well. Moreover, detailed descriptions of the illustrated expert models 306 are not provided herein, except as may be necessary or helpful in understanding operations of the routing layer 304.

Further in FIG. 3, the routing layer 304 is illustrated as including a routing node 330 that vectorizes the input tokens 302 and provides a resulting input vector for comparison with each of a plurality of routing vector nodes 332, 334, 336, 338, 340, 342, 344, and 346. As shown, the routing vector nodes 332, 334, 336, 338, 340, 342, 344, and 346 correspond to individual ones of the expert models 306, e.g., correspond respectively to the Business Activity Reporting (BAR) Lora expert 314, the situation Lora expert 316, the log/trace Lora expert 318, the graph Lora expert 320, the metric Lora expert 322, the Control-M Lora expert 324, the mainframe Lora expert 326, and the changes Lora expert 328.

As further illustrated, each routing vector node 332, 334, 336, 338, 340, 342, 344, and 346 has a corresponding, respective routing vector 332a, 334a, 336a, 338a, 340a, 342a, 344a, and 346a (also labeled as routing vectors V₁, V2, V₃, V₄, V₅, V₆, V₇, and V₈. As described above with respect to FIGS. 1 and 2, the input vector from the routing node 330 may be compared against each of the routing vectors 332a, 334a, 336a, 338a, 340a, 342a, 344a, and 346a, to obtain corresponding and respective gate activations 332b, 334b, 336b, 338b, 340b, 342b, 344b, and 346b, where the gate activations provide an example of a metric quantifying an extent to which a given routing vector has an affinity for, or is otherwise suited to, being processed by a given one of the expert models 306.

Put another way, the gate activations 332b-346b represent a probability distribution that the input vector representing the input tokens 302 may be suitably processed by the various expert models 306. As shown in the example, the gate activation 332b, corresponding to the routing vector 332a and the BAR Lora expert 314, has the highest affinity for processing the input tokens 302, while the gate activation 340b, corresponding to the routing vector 340a and the Metric Lora expert 314, has the lowest affinity for processing the input tokens 302.

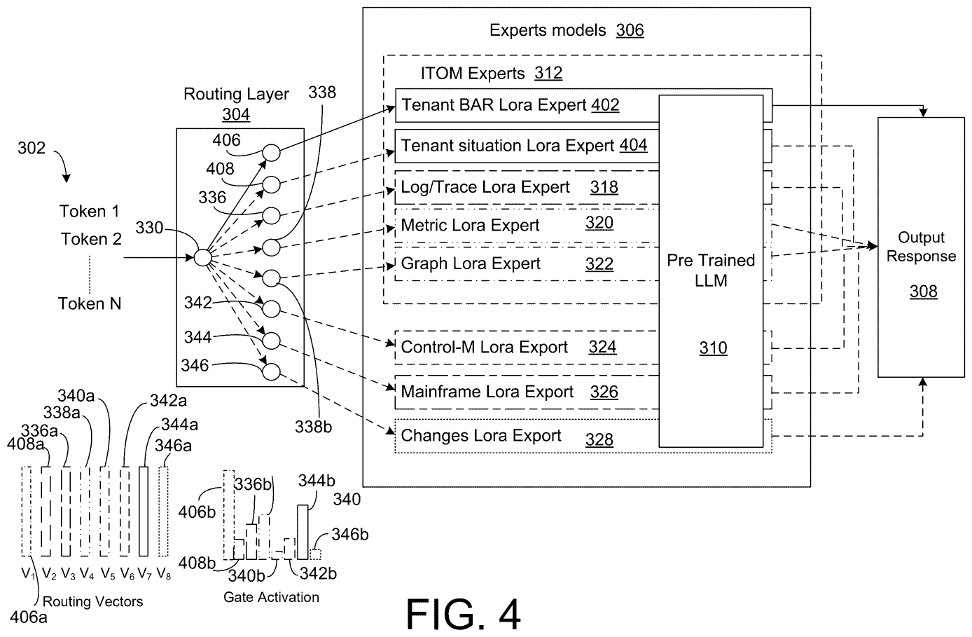

FIG. 4 is a block diagram illustrating the example of FIG. 3, with tenant-specific routing. That is, as referenced above, an advantage of described techniques is that they may be adapted to route input tokens 302 to any expert model added to the pool of expert models 306, even if the added expert models are specific to an individual tenant or other user.

For example, in FIG. 4, the BAR Lora expert 314 of FIG. 3 is illustrated as being replaced by a tenant BAR Lora expert 402, while the situation Lora expert 316 of FIG. 3 is illustrated as being replaced by a tenant-trained situation Lora expert 404. For example, the tenant BAR Lora expert 402 and the tenant situation Lora expert 404 may be trained using tenant-specific data. A routing vector node 406 associated with the tenant BAR Lora expert 402 may replace the routing vector node 332 of FIG. 3, while a routing vector node 408 associated with the tenant situation Lora expert 404 may replace the routing vector node 334 of FIG. 3. Therefore, a routing vector 406a replaces the routing vector 332a of FIG. 3, so that a gate activation 406b replaces the gate activation 332b of FIG. 3. Similarly, a routing vector 408a replaces the routing vector 334a of FIG. 3, so that a gate activation 408b replaces the gate activation 334b of FIG. 3.

Thus, FIG. 4 illustrates that the pool of expert models 306 may be modified as needed, including replacing existing models with tenant-specific expert models. New expert models may be included with their corresponding routing vectors, which may be developed together with one another and in isolation from other expert models/routing vectors. As a result, the pool of expert models 306 may be implemented as an adaptive, dynamic model pool, which may easily be modified to add and/or remove expert models (and corresponding routing vectors). Moreover, such additions and removals may occur without requiring changes to, or re-training of, other ones of the expert models or other ones of the routing vectors.

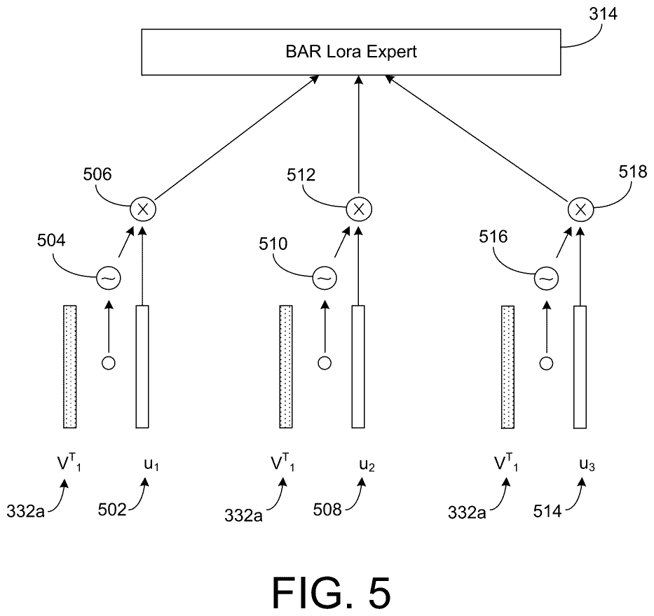

FIG. 5 illustrates example routing in the system of FIGS. 3 and 4. Specifically, in FIG. 5, the BAR Lora expert model 314 of FIG. 3 is associated with its routing vector 332a, as described above with respect to FIG. 3. In FIG. 5, the routing vector 332a is shown as a transposed vector V^{T} to be compared with a first input vector u₁ 502. That is, the input vector 502 represents a user query or other input, which has been embedded or vectorized within a same or common embedding or vector space as the various routing vectors. The transposed vector V^{T} may be used to align dimensions of the routing vector 332a and the input vector 502 for comparisons thereof, as described in more detail, below.

In particular, in FIG. 5, the routing vector 332a and the input vector 502 may be subjected to a batch normalization process 504 to account for potentially varying lengths of the input vector 502 relative to the routing vector 332a, so that a similarity comparison 506 may be made efficiently and meaningfully. That is, since user inputs may unpredictably vary in length depending on user needs, the batch normalization process 504 may operate to normalize sizes/lengths of the routing vector 332a and the input vector 502 to facilitate execution of the similarity comparison 506. For example, the similarity comparison 506 may include or represent a dot product, cosine similarity, and/or an affinity function.

Further in FIG. 5, a subsequent input vector 508 may be received and may undergo a batch normalization process 510 in conjunction with the same routing vector 332a of the BAR Lora expert model 314. Then, a similarity comparison 512 may be executed between the resulting, normalized routing vector and input vector. Additionally, input vector 514 may be received and may undergo a batch normalization process 516 in conjunction with the same routing vector 332a of the BAR Lora expert model 314. Then, a similarity comparison 518 may be executed between the resulting, normalized routing vector and input vector.

Thus, FIG. 5 illustrates that the BAR Lora expert model 314 has a corresponding routing vector 332a, which may be compared against any/all incoming input vectors to determine and evaluate a resulting activation for the BAR Lora expert model 314. As may be observed from FIGS. 3 and 4, similar comments apply to each of the various expert models 306 of FIG. 3 and their corresponding routing vectors, so that a probability distribution of gate activations may be determined (such as illustrated with respect to the various gate activations 332b-346b of FIG. 3).

In various examples, a resulting selection of one or more of the expert models 306 may thus be made. For example, a single expert model may be selected, or a combination of top-k models may be selected. For example, an input vector may be provided to a top-k number of expert models (perhaps weighted based on corresponding gate activations), and combined to obtain the final output response 308 of FIG. 3.

Thus, described techniques provide a multi-expert routing system for task- and tenant-specific expert models that do not require manual routing but are adaptive based on data. Automatic gating techniques utilize data distributed across multiple devices and domain topologies, including logs, metrics, traces, tickets, and incidents. An additional domain topology includes situations, or collections of events related to a specific issue or incident, which may be represented as situation event graphs, as referenced above and described in more detail, below.

Such automatic, real-time gating techniques may be provided by adaptively training a multi-expert routing model using topological, textual, log metric, incidents, and ticket data. As also referenced, received inputs may be routes to/among multiple experts through various tenant data sources across varied domains and services.

Provided automated routing utilized context not only from textual data but also from surrounding events, topology, logs, metrics, tickets, incidents, traces, and the temporal context of IT problems. Automated routers adaptively learn the routing of these custom experts through automatic gating using training data, enabling continuous adaptation and learning. Related processes may occur continuously, with routers being automatically updated, and new ones created whenever new tasks and domains emerge in the IT environment.

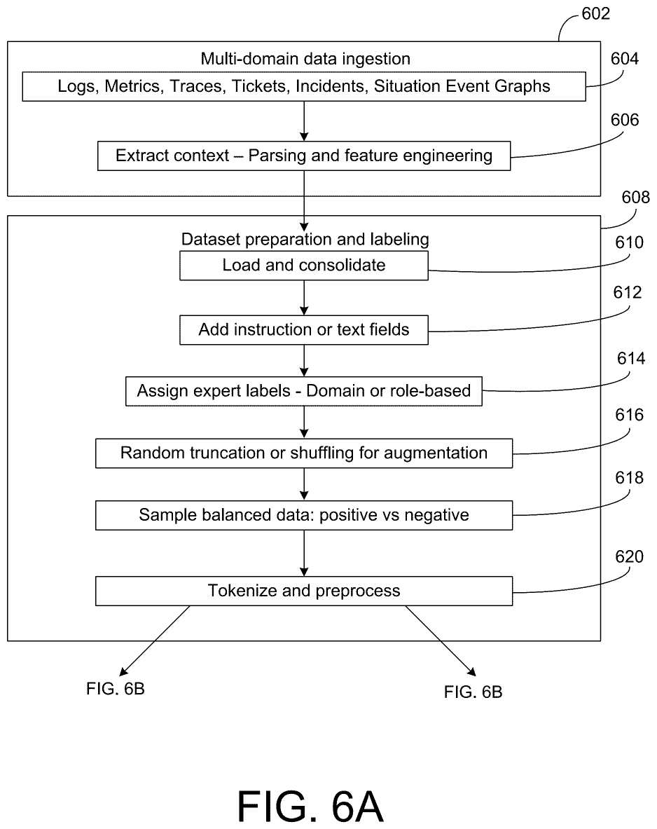

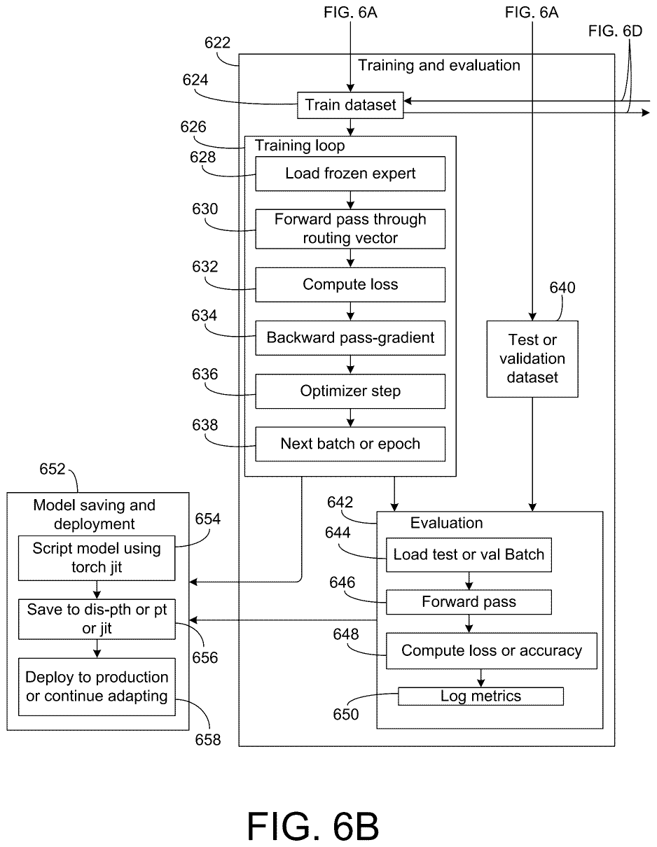

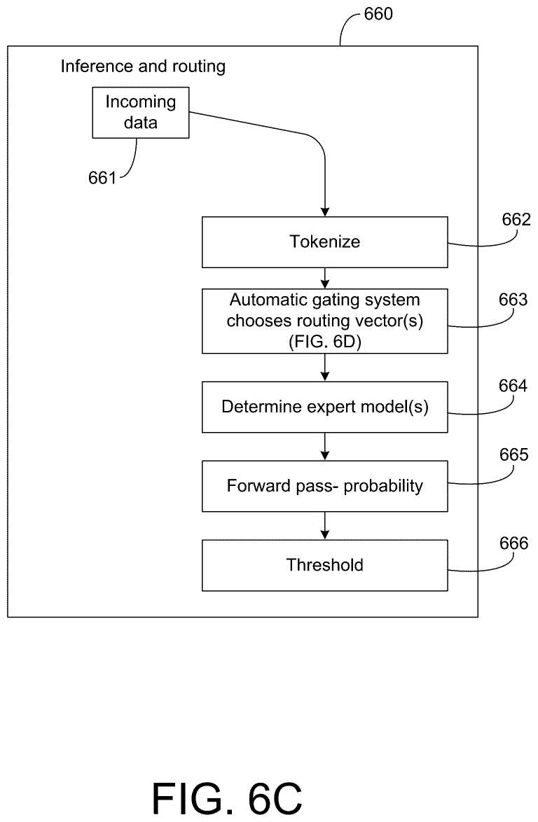

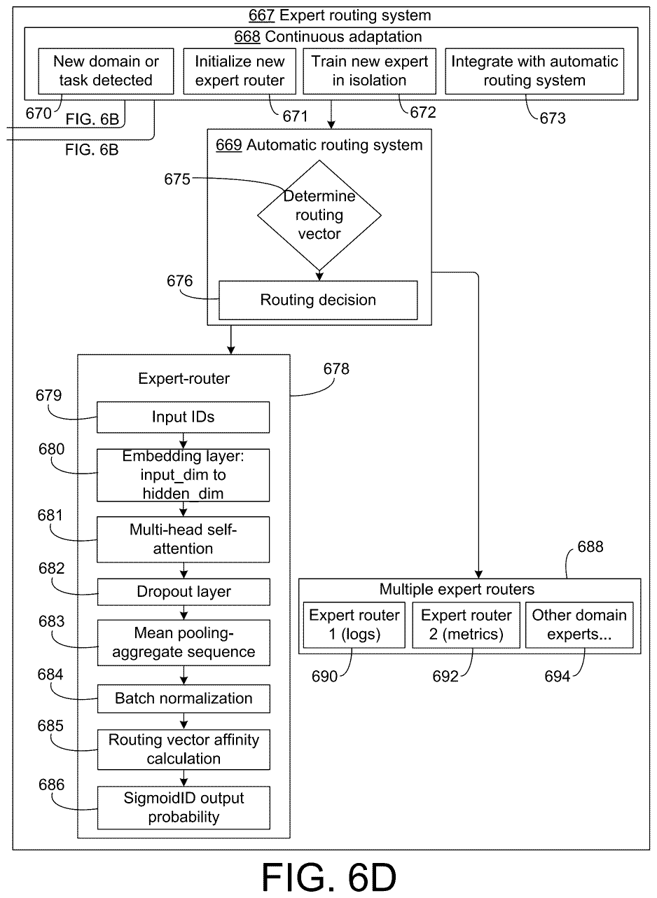

FIG. 6A is a flowchart illustrating example operations for receipt and preparation of training data to determine a routing vector for a corresponding expert model. For example, when it is desired to add a new expert model to an existing pool of expert models, the expert model may be trained using one or more known techniques (specific examples referenced below in the context of FIGS. 7-10). A corresponding routing vector may be trained with and/or using the expert model.

In FIG. 6A, multi-domain data ingestion (602) includes the receipt and collection of many different types and formats of raw data across multiple domain topologies (604), including logs, metrics, traces, tickets, incidents, and situation event graphs from various IT sources. Data ingestion (602) further includes extracting context from such raw inputs (606). For example, this may include transforming raw data (e.g., text, images, graphs) into meaningful features by identifying patterns, extracting relevant information (e.g., keywords or sentiment), and structuring the information for model understanding. Specific examples may include parsing sentences for syntax or converting unstructured data to structured data (e.g., named entity extraction).

Then, during dataset preparation and labeling (608), data may be loaded and consolidated (610). For example, data may be gathered from various sources (databases, files) and merged into a unified format for processing. Instruction or text field may be added (612). For example, this operation(s) may add or refine textual fields, graphs, or time series data and/or may enhance data by adding metadata, converting instructions to text, or formatting time series/graph data for consistency.

Expert labels may then be assigned (614). For example, data may be tagged with labels based on predefined rules or expert knowledge, where the labels may be domain or role-based. For example, data may be labelled log data for a log expert model.

Augmentation may be provided by random truncation or shuffling (616). For example, data entries may be randomly shortened or reordered to increase variety, which may assist with generalization.

The data may be sampled in a balanced manner (618). For example, balanced sampling may account for positive/negative classes, e.g., may ensure equal representation of classes by selectively sampling to avoid bias.

During tokenization and preprocessing (620), text may be broken into tokens (e.g., words or subwords). Final adjustments, such as lowercasing or removing noise may be made. Finally, as shown in FIG. 6B, resulting data may be split into a training set and a test set (622).

FIG. 6B is a flowchart example training operations using the prepared training data of FIG. 6A. As just referenced, and as shown in FIG. 6B, processed data is split into training dataset (624) and testing/validation dataset (640).

Then, during a training loop (626), a previously trained expert model, for which a routing vector is being constructed, may be loaded with its weights frozen (628). The training loop (626) further includes, for a current batch or epoch, a forward pass through the routing vector (630), in which input data is processed to generate outputs based on current weights. During loss computation (632), predictions are compared to true labels to measure prediction error. For example, Binary Cross Entropy (BCS) loss or a variant may be used.

During a backward pass operation (634), gradients of the computed loss may be determined with respect to each parameter using backpropagation, determining how weights should adjust. For example, backpropagation may be used for computing gradients of the loss function being used with respect to relevant parameters, and gradient descent may be used as an optimization algorithm that uses those gradients to iteratively update the parameters in the direction that minimizes the loss.

During an optimizer step (636), an optimizer updates weights using the gradients, aiming to minimize the loss for the next training iteration. For example, an optimizer known as the Adaptive Moment Estimation (Adam) may be used, which is an optimization algorithm that combines adaptive learning rates with momentum, using estimates of first and second moments of gradients to accelerate convergence. Adam is designed to leverage adaptive learning rates and momentum to accelerate convergence and handle sparse gradients effectively. Finally in the training loop (626), training may continue with a next batch or epoch (638) of the training dataset (624).

In more specific examples, after completing the training of an individual expert model, the trained expert model may have its weights frozen as referenced above and a sigmoid gate layer may be added that precedes an adapter module implementing the expert model functionality within a foundational LLM, as referenced with respect to FIG. 3 and described in more detail below with respect to FIGS. 7-10. Subsequently, this sigmoid gate layer is trained using the same training data and loss function as the expert model, while keeping all other parameters frozen, including the expert/adapter weights.

Although the same training data may be used, only a relatively limited number of iterations are needed in comparison to the number of iterations needed for the expert model itself (e.g., approximately only one hundred iterations). The sigmoid gate determines whether a specific activation (e.g., user input uₜ) will utilize the corresponding expert model. For example, a linear layer may be used that transforms to Wuₜ+BAuₜσ(v^{T}uₜ), where v∈ [symbol] represents the trainable routing vector (initialized to zeros), and W, B, and A remain fixed.

Further in FIG. 6B, the test/validation dataset (640) may be used to perform an evaluation (642). As shown, batches of the test/validation dataset (640) are loaded (644). Then, similar to the training loop (626), the batch undergoes a forward pass (646), and metrics such as loss/accuracy may be computed (648). Metrics characterizing an accuracy or other aspect of the routing vector being trained may then be logged (650) to be used in evaluating the trained routing vector.

During model saving and deployment (652), the expert model and its trained and validated routing vector may be provided in a manner that facilitates portability and distribution. For example, models may be scripted (e.g., using torch.jit.script) for portability (654). For example, this step may convert the trained expert model/routing vector into a TorchScript format, enabling it to run efficiently across different environments without Python dependency. TorchScript format is a serialized representation of a PyTorch model that combines the model's graph and code into a single executable, allowing it to run independently of Python in production environments like C++. Accordingly, the determined weights and structure may be stored in portable formats (656), such as .pth (state dictionary is saved), .pt (entire model is saved), or .jit (TorchScript), ensuring easy reloading or deployment.

Finally in FIG. 6B, the trained expert model and routing vector may be deployed to production or kept in a loop for retraining/updates/adaptations (658). For example, the saved expert model/routing vector may either be deployed to production for real-world inference or integrated into a pipeline for ongoing retraining with new data to improve performance.

FIG. 6C is a flowchart illustrating example inference and routing operations (660). In FIG. 6C, incoming data (661) may be received from any number of domain sources, and may be tokenized (662) using the same tokenizer used during training.

Then, the automatic gating system described herein chooses a routing vector(s) (663). Additional example details of the automatic gating system and processes for choosing a routing vector(s) are provided below, with respect to FIG. 6D.

Based on the selection of the routing vector(s), a corresponding expert model(s) may be selected (664). The chosen routing vector(s) may then be used to perform a forward pass to output a selection probability (665). For example, a percentage may be provided indicating a degree of similarity between the received input and each routing vector(s).

A thresholding operation (666) may be performed to determine which, if any, of the probabilities exceed a pre-set threshold for selection of a corresponding expert model(s). For example, if a threshold percentage is set relatively high, then it is more likely that a single expert model may be selected, whereas lower thresholds would imply greater likelihood that a set of top-k expert models will be selected. If no expert models meet the threshold, then the threshold may be lowered incrementally and/or a new expert model and corresponding routing vector may be trained using the techniques of FIGS. 6A and 6B.

FIG. 6D is a flowchart illustrating example routing operations for the inference operations of FIG. 6C. In FIG. 6D an expert routing system 667 is capable of providing continuous adaptation (668) to be able to route new and existing input data, while an automatic routing system 669 may be configured to determine a probability distribution of routing vectors/expert models for use in the inference and routing operations of FIG. 6C.

Continuous adaptation (668) includes detection of any new domain or task (670). If such detection occurs, then operations of FIG. 6B may be triggered. A new routing vector is initialized (671), e.g., defined and set to zero value(s). A corresponding expert model is trained in isolation (672). Once the new expert model and its associated routing vector are generated, they may be integrated with the automatic routing system 669 (673).

If an existing domain/task is determined, then the automatic routing system 669 may determine which routing vector(s) to select and use (675) and then make a corresponding routing decision (676), e.g., as described above with respect to FIG. 6C. Thus, FIG. 6C and FIG. 6D illustrate an automatic gating system that provides a specialized mechanism to decide which expert router handles a given input, with learned gates automatically adapting to new tasks.

Further details of example operations of the automatic routing system 669 are illustrated with respect to an expert router 678, representing a detailed or exploded view of any one of multiple expert routers 688. For example, the multiple expert routers 688 are illustrated as including an expert router 690 configured for processing log records, an expert router 692 configured for processing metrics, and an expert router 694 configured for processing various other types of domain records.

The expert router 678 illustrates an example process flow for making routing decision(s) 676. As shown, operations may begin with receipt of an input ID uₜ (679), input of a tokenized user request (e.g., words or subwords from a vocabulary), in which the IDs are integers mapping to tokens, and ready for embedding into a continuous vector space.

At an embedding layer, each input ID is passed through for transformation from an input dimensionality into a vector of a size corresponding to a hidden layer dimensionality (680), resulting in a sequence of embeddings. The embedding layer thus maps discrete tokens into a continuous space where semantic relationships can be captured.

The resulting sequence of embeddings is then processed by a multi-head self-attention layer (681), having a given number of heads, and allowing each token to attend to all others in the sequence. As a result, a new sequence is produced that captures dependencies between tokens (e.g., understanding context in the user request).

A dropout layer may be used (682) that introduces or resets values to zero and scales remaining values. Using the dropout layer can enhance reliability and prevent over-reliance on a single expert (e.g., when affinities are close).

Then, during a mean pooling/aggregate sequence operation (683), sequences obtained from the dropout layer may be aggregated into a single (pooled) vector by computing a mean across a sequence dimension to create a fixed-size representation of the user request. This approach effectively summarizes the contextualized embeddings into a single vector for routing.

During batch bormalization (684), the pooled vector is passed through a batch normalization layer, e.g., standardizing the pooled vector across a batch of requests by subtracting the batch mean and dividing by the batch standard deviation (with learnable scale and shift parameters), yielding a normalized vector.

A routing vector affinity calculation (685) may then be performed. That is, for the relevant expert model, an affinity score may be calculated that measures an extent of alignment between the normalized user request vector and the specialty of the expert model. For example, as described herein, the dot product between the input vector as processed above and the relevant routing vector may be used to quantify the relevance of the expert for the request.

A sigmoid output probability may then be calculated (686). For example, calculated affinity scores may be scaled based on a number of expert models being used and then passed through a softmax function over the set of expert models. In this way, gate activation probabilities for routing the request to each expert may be determined. This approach ensures the calculated weights/probabilities sum to one, enabling soft routing in which experts contribute proportionally to their relevance.

Thus, after training multiple expert models (e.g., expert adaptors as described in detail below with respect to FIGS. 7-10) and their respective routing vectors, expert routers can be constructed using the trained routing vectors vₐ, v_{b}, v_{c}, . . . to facilitate top-k routing during inference. A distinct router can be established at each layer at which modules are introduced to enable per-expert module routing.

As described above with respect to FIG. 6D, both the routing vectors indicated by v̅ₐ, v̅_{b}, v̅_{c}, . . . and a given activation denoted by ūₜ may be normalized by subtracting the mean and dividing by the variance across the dimensions for routing purposes. Each expert model's score may then be assessed by calculating the cosine similarity between ūₜ and that expert's routing vector. Subsequently, ūₜ is directed to the expert model(s) with the highest k scores, with their output adjusted using softmax-normalized weights.

In more specific examples, during inference, the affinity α_{t,z} between expert adapter module z and activation uₜ is calculated as

$${\overline{v}}_{z}^{T} {\overline{u}}_{t} .$$

The set εₜ of the top-k expert adapter modules for a given activation may then be assembled by selecting εₜ=top−k(α_{t,a}, α_{t,b}, α_{t,c}, . . . ). Subsequently, weights for scaling each expert adaptor module are computed as wₜ=softmax ({α_{t,z}/\sqrt{n}, z∈εₜ}) where the scaling by 1/\sqrt{n} is included to prevent saturation of the softmax when supplied with dot products of standardized vectors. Finally, the output of the linear layer for activation uₜis computed as Wuₜ+Σ_{z∈ε}_{ₜ} w_{t,z} B_{z}A_{z}u_{t,z}

As represented by the arrows between the training dataset 624 of FIG. 6B and the continuous adaptation module 668 of FIG. 6D, new data, new domains, and/or calculated outcomes can trigger the system to adapt. That is, whenever new tasks, domains, or anomalies arise, the system initializes a new expert or updates an existing one in an online or continual learning manner.

Described techniques thus provide an automatic gating system that an appropriate expert model dynamically and without requiring a global retraining of all experts when new experts are added or when experts are removed. As just referenced, continuous adaptation ensures new experts can be trained in isolation on new domains or tasks, then plugged in to the routing/gating system. Multiple data sources across multiple IT topologies may be leveraged to continuously feed context and insights, allowing an incremental or continuous update strategy. Further, as expert models are individually maintained and updated, a need for a monolithic re-training whenever a new domain emerges is removed, contributing to a high degree of scalability of the system.

Following FIGS. 7-10 are primarily described in scenarios in which an event graph (also referred to as an event cluster, or a situation) is represented as a graph of multiple events. Such an event graph may be associated with event text (e.g., descriptive text). For example, a situation may include a large-scale situation such as a system-wide crash. In other examples, the situation may include a smaller scale situation such as a component freeze. In general, the situation may be considered to include one or more events that require attention, repair, or remediation, or that have some other consequence for users of an IT landscape.

Such an event graph and associated event text represent only a single example of the many different types of IT data, or other types of data, that may be processed using described techniques. Nonetheless, following examples illustrate how different expert adaptor modules may be used to process either graphical/topological or textual inputs, using the example techniques of FIGS. 1-6D.

For example, an event graph and event text, perhaps with relevant network context, may be processed by the type of large language model (LLM) referenced above, e.g., with respect to FIG. 3. For example, such network context may include network topology data and/or knowledge graph data that may be relevant to the event graph and associated event text.

As described above, such an LLM may include an expert model, which may include one or more topological context adapter(s) and associated hyperparameter(s), as described in more detail, below. In particular, detailed discussions of example structures of the LLM and of the expert model, including the topological context adapter(s) and associated hyperparameter(s), are provided below, e.g., with respect to FIGS. 7-10.

FIG. 7 is a block diagram of an example transformer layer that may be used to implement the systems of FIGS. 1 and 3. More specifically, for example, the transformer layer 702 may be included in the LLM 310 of FIG. 3. Other portions of the LLM 310, by themselves, are known and are not described here in further detail, except as needed to understand described techniques.

In general, transformer layer(s) of a LLM, such as the LLM 310 are designed to convert a type of input into a desired type of output. For example, in the context of language translation, transformer layers may be used to translate English sentences into Spanish sentences or perform any desired translation.

For example, the transformer layer 702, and/or preceding layers of the LLM not explicitly shown in FIG. 7, may be configured to receive textual inputs and provide corresponding embeddings and positional encodings. For example, a received sentence may be assigned an embedding for each word, as well as a positional encoding for a position of each word within the sentence.

A multi-head attention layer 704 may be configured to determine internal relationships between elements of the input text. For example, the concept of attention in the context of the transformer layer 702 may refer to determinations of relationships between words in a sentence, or among different sentences. Consequently, attention enables disambiguation of words, relationships between pronouns and their corresponding antecedents, entity identification, and general awareness of relative levels of importance of individual words or phrases within the context of the overall input text. In FIG. 7, the term multi-head generally refers to the use of multiple different types of attention mechanisms and associated areas of focus (e.g., shorter-term dependencies or longer-term dependencies) within the input text. In this way, multiple types of attention may be calculated in parallel for improved processing efficiencies.

As further shown in FIG. 7, the inputs of the multi-head attention layer 704 (e.g., word embeddings and positional encodings) may be combined with the outputs of the multi-head attention layer 704, in a process known as a skip connection. Such a skip connection maintains information regarding the input embeddings and/or encodings that might otherwise be lost during the attention calculations, while also facilitating backpropagation operations during training of the transformer layer 702.

The combined inputs and outputs of the multi-head attention layer 704 may then be fed to a normalization layer 706. Such normalization restricts a range of the received, aggregated values, which, e.g., avoids overly large values that can lead to training errors, and generally facilitates determinations of optimal values during back propagation processes, e.g., by keeping available values within a known range. FIG. 7 illustrates an example of layer normalization, in which normalization is applied on a layer-by-layer basis within a neural network being processed, but other types of normalization may be used, as well.

A feed-forward layer 708 refers to a feed-forward network, including an input layer, desired number of hidden layer(s), and an output layer. The feed-forward layer 708 includes edges between the various nodes of the aforementioned layers that are assigned corresponding weights and biases, along with an activation function associated with the nodes. Then, as described above, a residual or skip connection enables a combination of the inputs and outputs of the feed-forward layer 708, followed by another normalization layer 710.

All of the layers 704, 706, 708, 710 may be processed during training operations to assign values to include weights and any other trainable parameter(s), referred to cumulatively herein as weights. As known for LLM transformers such as the transformer layer 702, and as referenced above, such training may be conducted using parallel operations and corresponding parallel processors/processing, to process large amounts of training data. Using such techniques, a conventional transformer may be trained (i.e., weights may be assigned to the various layers 704, 706, 708, 710), to, e.g., provide useful summaries of received text.

Such summaries are available only for received text when using text adapters, whereas, in FIG. 7, a topological context adapter 712, representing an example of topological context adapter(s), may be added to the illustrated transformer pipeline. As shown, a topological context adapter 712 is positioned following the multi-head attention layer 704, while a topological context adapter 714 is also added following the feed-forward layer 708. Such topological context adapters 712, 714 thus enable processing of an event graph or other graph representations of network situations.

For example, the topological context adapters 712, 714 may be configured to input and process graphs, such as an event graph, together with event text. For example, the transformer weights of the layers 704, 706, 708, 710 may be frozen or held at constant values determined from previous training, while adapter weights of the topological context adapters 712, 714 are updated during a subsequent fine-tuning training process that includes training performed with respect to event graphs, topology graphs, and/or knowledge graphs.

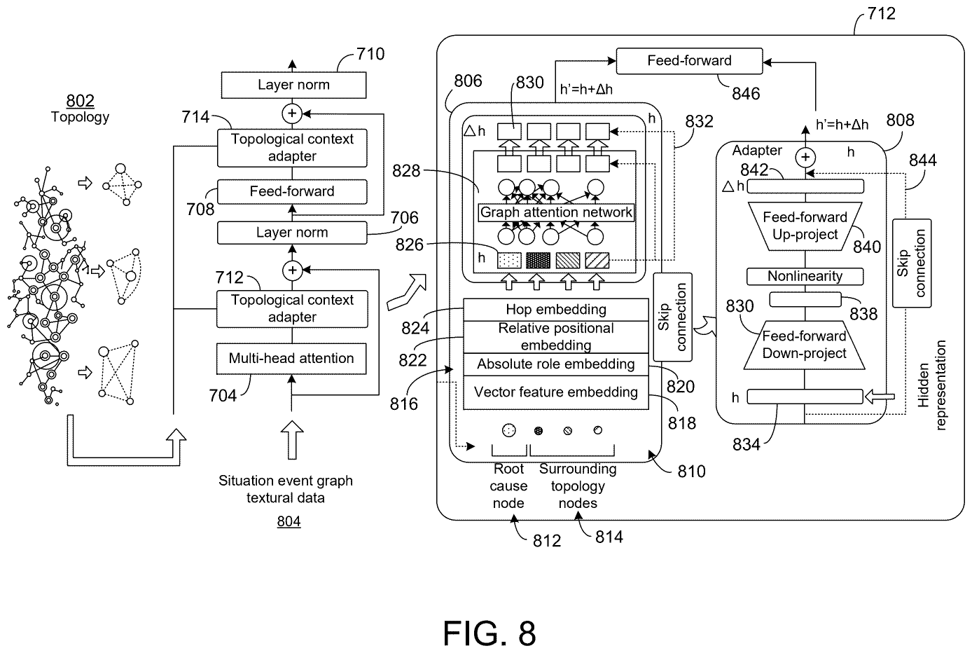

More specifically, as shown in FIG. 8, graph data 802 may be provided to the topological context adapters 712, 714, while event graph text 804 is provided as input to the multi-head attention layer 704. FIG. 8 further illustrates an exploded view of the topological context adapter 712.

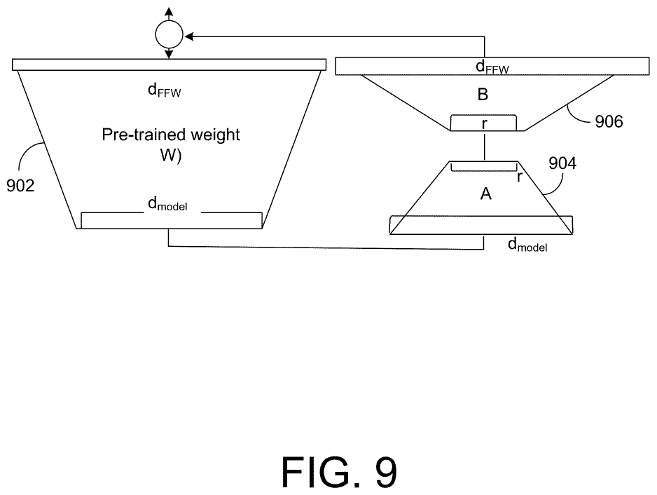

As illustrated in FIG. 8, and as referenced earlier in the examples of FIGS. 2A and 2B, the topological context adapter 712 includes a graph adapter 806 and a text adapter 808. The graph adapter 806 may be trained and otherwise configured to process graph data, as just referenced. Meanwhile, the text adapter 808 represents any suitable network suitable for processing text, specific examples of which are provided with respect to FIGS. 8 and 9. In the following description, the term adapter weights is used to refer collectively to all weights of the topological context adapter 712, while the term graph adapter weights refers to weights of the graph adapter 806, and the term text adapter weights refers to weights of the text adapter 808.

As illustrated and described with respect to FIG. 8, both the graph adapter weights and the text adapter weights may be trained together (and with corresponding adapter weights of the topological context adapter 714), while remaining transformer weights of the layers 704, 706, 708, 710 are held frozen at previously determined values. Consequently, such training of the graph adapter weights may be performed in a customized, efficient manner.

In FIG. 8, an event graph 810, including a root cause node 812 and surrounding topology nodes 814, is illustrated as being input to the graph adapter 806. More specifically, the event graph 810 is illustrated as being input to graph embedding layers 816. As described in detail, below, the graph embedding layers 816 may include one or more layers for determining an embedding of the event graph 810, so that the resulting graph embeddings may be processed by a graph attention network 828.

In the example of FIG. 8, the graph embedding layers 816 include a vector feature embedding layer 818. Conceptually, the vector feature embedding layer 818 is designed to capture node features of individual nodes of the event graph 810. For example, node features may include, for a given node, an associated device type (e.g., router, switch, or load balancer), application, or business service, as well as associated details that may be specific to the individual device (e.g., network interface characteristics). As referenced above, some device features may be determined from corresponding topology data and/or knowledge graph(s).

Then, the vector feature embedding layer 818 may be configured to convert such node features into a corresponding embedding(s), providing a numerical representation of the above-referenced types of node features, in which similar node features will be embedded close to one another within the vector space of the embeddings. For example, nodes for two different types of routers may have similar vector feature embeddings, while a node for a virtual machine and a Kubernetes port may have dissimilar vector feature embeddings.

In an example formal representation, for each node vⱼ∈Vi in the subgraph gᵢ, a raw feature vector can be embedded into a shared feature space (of the same dimension dₕ) with its raw feature vector xⱼ, which can be denoted as:

$${e}_{j}^{( x )} = Embed ( {x}_{j} ) ∈ R dh \times 1$$

An absolute role embedding layer 820 may be configured to embed features related to a role of a node within a graph. For example, a node's role may relate to various types of graph invariants, such as vertices, edges, and degree. For example, a graph node may provide the role of a hub, a spoke, or a leaf node. Therefore, for example, a hub node with many edges will have an absolute role-embedding aspect similar to another hub node with a number of edges, and both may have dissimilar embeddings with respect to a leaf node with a single edge.

The Weisfeiler-Lehman (WL) algorithm may be used to label the nodes according to their structural roles in the graph data, with nodes having identical roles being labelled with the same code. Formally, for node vⱼ∈Vᵢ in the sampled subgraph, its WL code can be denoted as WL(vⱼ)∈N, which can be pre-computed based on the complete graph and is invariant for different sampled subgraphs:

$${e}_{j}^{( r )} = Embed ( WL ( {v}_{j} ) )$$

A relative positional embedding layer 822 determines embeddings based on relationships between nodes, i.e., based on relationships between underlying devices, interfaces, applications, services, or other node features, as well as relative orders or sequences of the nodes and features. For example, a relative positional embedding may identify a router connected to an interface, or vice versa, in a causal manner. Thus, for instance, a generated narrative may more easily determine potential causations within an analyzed graph, which may or may not be explicitly reflected within the graph being processed. That is, although various types of causation may be determined and reflected in a graph, the relative positional embedding layer 822 (similar to other embeddings) may further determine similarities between many different pairs and sequences of nodes across many analyzed graphs, to determine and characterize such relative positions more completely and more accurately.

The WL-based role embeddings referenced above may be used to capture global node role information in embeddings. For example, a relative positional embedding may be introduced to extract local information in a subgraph based on the placement orders of the serialized node list discussed above. Formally, based on that serialized node list, the position of vⱼ∈Vᵢ can be denoted as P(vⱼ). Because P(vᵢ)=0 by default and nodes closer to vᵢ will have a small positional index, and, furthermore, P(·) represents a variant position index metric, then for the identical node vⱼ, its positional index P(vⱼ) will be different for different sampled subgraphs:

$${e}_{j}^{( p )} = Position - Embed ( P ( {v}_{j} ) )$$

A hop embedding layer 824 produces embeddings reflecting relative distances between graph nodes. For example, such hop embeddings may capture or characterize whether a pair of nodes are separated by 0, 1, 2, or more intervening nodes. Nodes that are connected by multiple intervening paths (and corresponding numbers of nodes) may also be characterized, and/or a shortest-available connection may be effectively identified.

Hop-based embedding can be treated as a balance between absolute role embedding (for global information) and intimacy-based relative positional embedding (for local information). Formally, for node vⱼ∈Vᵢ in the subgraph gᵢ, relative distance in hops relative to vᵢ in the original input graph may be denoted as H(vⱼ; vᵢ), which can be used to define an embedding vector as:

$${e}_{j}^{( d )} = Embed ( H ( {v}_{j} ; {v}_{i} ) )$$

Calculated embeddings may then be aggregated and passed to an input layer 826 for a graph attention network 828. More specifically, using the computed embedding vectors defined above, initial input vectors for nodes may be defined, e.g., as vⱼ, in the subgraph gi as follows:

$${h}_{j}^{i} = Aggregate ( {e}_{j}^{( x )} , {e}_{j}^{( r )} , {e}_{j}^{( p )} , {e}_{j}^{( d )} ) .$$

The graph attention network 828, similarly in concept to the multi-head attention layer 704, processes input vectors to determine and identify particular nodes, edges, or graph portions for particular attention when generating a narrative or a remediation for the graph being processed. Also similar to the structure and approach of the transformer layer 702, skip connections 832 may be used to provide input values of vector(s) h, at output layers 830.

During training of the graph adapter 806, an error between the generated graph narrative (or remediation) output from the graph adapter 806 may be compared to a labeled, ground truth narrative for the graph being processed, so that an error Δh between the ground truth narrative and the generated narrative may be determined. Then, backpropagation may be used to proceed back through the graph attention network 828 and the graph embedding layers 816, to correct adapter weights (including vector embedding weights) for the graph adapter 806 in a manner that operates to minimize the error Δh. Over many such processing cycles, the error may thus be reduced, and the graph adapter 806 may be trained to conform to corresponding training data. Then, during inference operations, the graph adapter 806 may operate to provide accurate and complete narratives for newly received graphs.

Similar comments apply to the text adapter 808. Specifically, an input layer 834 may be trained to generate a hidden value vector representation for forwarding to a feed-forward down-project 830, for further processing by a nonlinear layer 838 and a feed-forward up-project 840. As with the graph adapter 806, output layer 842 provides an output Δh that may be added to the original value h through skip connection 844 and modified during subsequent backpropagation operations to minimize an error in operations of the text adapter 808. Then, a feed-forward neural network layer 846, similar to the feed-forward neural network layer 708, may be used to combine outputs of the graph adapter 806 and the text adapter 808, for forwarding within the larger pipeline of the transformer layer 702 of FIG. 7.

In the example of FIG. 8, the text adapter 808 utilizes a low-rank adapter (LoRa) approach in which the various model weights are represented as a matrix W of weights, where the matrix W has a degree d that corresponds to the larger LLM of which the topological context adapter 712 is a part. In other words, the matrix W includes the pre-trained weights of the larger LLM, which may advantageously be frozen for purposes of training the topological context adapter 712. The matrix W is not shown separately in FIG. 8, but is represented in FIG. 9 as weight matrix 902.

Such a matrix W may typically have a relatively large dimension d, but may be decomposed into two smaller matrices A and B, shown in FIG. 9 as low-rank matrix 904 (corresponding to the feed-forward down project 830 of FIG. 8) and low-rank matrix 906 (corresponding to the feed-forward up project 840 of FIG. 8). That is, a rank r of the two matrices 904, 906 may be much smaller than a rank of the original matrix W, but may contain a subset of weights of the matrix W that are most pertinent to training the text adapter 808. For example, the matrix W may be decomposed by keeping only linearly independent columns, while removing linearly dependent columns, which retain much of the relevant information needed for subsequent training while greatly reducing a quantity of time and processing resources needed for training.

Then, as understood from FIG. 9, the values of the weights of the matrices 904, 906 may be updated during fine-tuning training, while the pre-trained values of the original matrix 902 are held constant. As shown, the degree d_{model} of inputs to the weight matrix 902 and the weight matrix 904 is the same, while the degree d_{FFW} of the outputs of the weight matrix 902 and the weight matrix 906 to a subsequent feed-forward neural network layer are the same, so that the combination of vectors modified by the weight matrix 902 and the weight matrices 904, 906 may be easily combined.

Further, as the rank r is much less than the rank d, the fine-tuning training may be performed much faster and more efficiently than would be required if the original matrix W were updated. Put another way, a weight after fine-tuning may be written as W₀ (pre-trained weight)+ΔW (updates to the weight), where updates to the weight (ΔW) have a low intrinsic rank, and so that a resulting fine-tuned weight may be provided as W₀+ΔW=W₀+BA, rank r<<min (d_{FFW}, d_{model}).

Thus, FIGS. 7-9 illustrate example uses of various context adapters, various combinations of which may be defined and trained, together with selected hyperparameter values, to define various ones of the expert models described herein. For example, a rank hyperparameter may define a percentage of weights to be trained for a given expert model, which thus limits a corresponding quantity of processing resources required and increases a speed and efficiency of processing data with such an expert model.

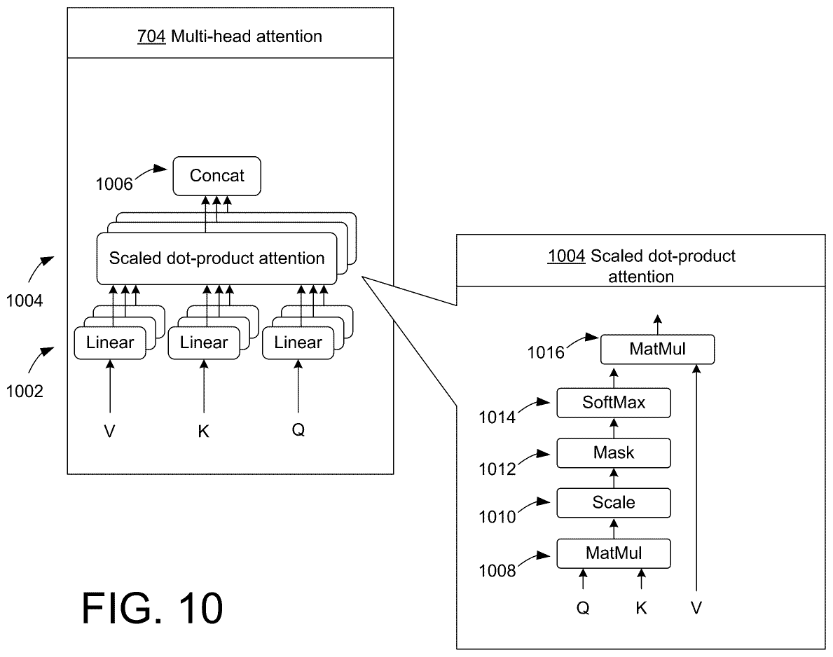

FIG. 10 is a block diagram of the multi-head attention layer 704 of FIG. 7. Example layers 1002, 1004, and 1006 of the multi-head attention layer 704 are shown for context and completeness, but descriptions of functions of these layers that are not useful for understanding remaining FIGS. 11-15 are omitted for the sake of clarity and conciseness.

As shown, the multi-head attention layer 704 inputs key (K), value (V), and query (Q) states. Following linear processing at layer 1002, a scaled dot-product attention layer 1004 calculates attention tokens that are concatenated at layer 1006. The exploded view of the scaled dot-product attention layer 1004 illustrates more specifically that Q, K are input through a matrix multiplication layer 1008, a scaling layer 1010, a masking layer 1012, and a softmax layer 1014, after which obtained results undergo matrix multiplication at layer 1016 with the value V.

Thus, conventional LLMs rely on textual data from events for inference, which restricts an ability to grasp a complete context, where such context may span across various devices and domain topologies, encompassing logs, metrics, traces, tickets, and incidents. Described techniques provide a multi-expert system equipped with task- and tenant-specific adapters, which can be continuously and incrementally trained. This approach facilitates optimal reasoning for determining root causes, assessing impacts, providing explanations, and implementing remedies sourced from diverse domains in real-time. Adopting such a strategy enables IT teams to concentrate their efforts on comprehensively resolving underlying issues by harnessing data from multiple domains, rather than merely addressing surface-level symptoms. Consequently, this leads to more efficient and effective problem resolution.

Described techniques provide an ability to train, manage, and serve numerous independent experts across different domains simultaneously. This is achieved, e.g., by an incremental training framework that can load numerous independent expert adapters or other models into main memory and fetch the adapters used by the currently running queries to the GPU memory to manage numerous expert adapters. Each of these expert adapters utilizes data distributed across several devices over multiple domain topologies, including logs, metrics, traces, tickets, and incidents, as well as situation event graphs. This is accomplished, for example, through adaptively training a multi-expert GPT model using topological, textual, log metric, incidents, and ticket data by incrementally combining multiple historical expert adapter models into a single multitask model without performing additional training.

Additionally, multiple experts may be managed and trained in a scalable way using custom quantization strategies through various tenant data sources across varied domains and services. In particular, described techniques capture context from data distributed across several devices over multiple domain topologies, including logs, metrics, traces, tickets, incidents, and situation event graphs. Such processes follow training multiple expert adapters using a custom LLM Algorithm, which may be based on a Generative Pretrained Transformer. This model comprehends context not only from textual data but also from surrounding events, topology, logs, metrics, tickets, incidents, traces, and the temporal context of IT problems. It may generate a human-readable runbook that not only summarizes the root cause and symptoms but also includes topological characteristics, remediation steps, and comprehensive problem analysis.

As described above, sustaining the stability and reliability of large-scale networks is important in the IT management area. However, it is challenging to achieve in a practical IT environment due to the dynamic, ever-growing, and distributed nature of large-scale enterprise networks. Effective management of these environments benefits from an in-depth understanding of multiple domains to comprehend and communicate the problems. Hence, effective analysis, explanation, and remediation of IT problems using large language models are significant for high-availability systems. However, inference based solely on textual data from events limits the ability to grasp the overall context, which is distributed across several devices over multiple domain topologies, including logs, metrics, traces, tickets, and incidents. Described techniques provide a multi-expert routing system with task- and tenant-specific adapters that do not require manual routing but are adaptive based on data, using automatic gating. This approach enables performance of the best reasoning for root cause, impact, explanation, and remediation from numerous sources in various domains. Considering this can help IT teams focus their efforts on resolving the underlying issue comprehensively, leveraging data from various domains rather than addressing symptoms, leading to more efficient and effective problem resolution.

These and other advantages are obtained by leveraging automatic gating, which utilizes data distributed across several devices over multiple domain topologies, including logs, metrics, traces, tickets, and incidents, as well as Situation Event Graphs. This is accomplished through adaptively training a multi-expert routing model using topological, textual, log metric, incidents, and ticket data within an automatic gating system.

Additionally, routing is provided among multiple experts through various tenant data sources across varied domains and services. This process involves training multiple expert routers using the automatic gating system. This router comprehends context not only from textual data but also from surrounding events, topology, logs, metrics, tickets, incidents, traces, and the temporal context of IT problems. The routers adaptively learn the routing of these custom experts through automatic gating using training data, enabling continuous adaptation and learning. Additionally, techniques are provided for routing multiple experts through various tenant data sources across varied domains and services.

Implementations of the various techniques described herein may be implemented in digital electronic circuitry or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers, including mainframes and distributed servers, at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may, or be operatively coupled to, receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive an input vector;
determine a first similarity metric between the input vector and a first routing vector associated with a first model;
determine a second similarity metric between the input vector and a second routing vector associated with a second model; and
route the input vector to the first model, based on the first similarity metric and the second similarity metric.

2. The computer program product of claim 1, wherein the instructions are further configured to cause the at least one computing device to:
receive an input; and
embed the input within a vector space that is common to the first routing vector and the second routing vector to obtain the input vector.

3. The computer program product of claim 1, wherein the instructions are further configured to cause the at least one computing device to:
determine a first cosine similarity as the first similarity metric; and
determine a second cosine similarity as the second similarity metric.

4. The computer program product of claim 1, wherein the instructions are further configured to cause the at least one computing device to:
train the first routing vector using at least a subset of a training dataset used to train the first model, and using a loss function used to train the first model.

5. The computer program product of claim 4, wherein the instructions are further configured to cause the at least one computing device to:
train the second routing vector using at least a subset of a second training dataset used to train the second model, and using a second loss function used to train the second model.

6. The computer program product of claim 1, wherein the instructions are further configured to cause the at least one computing device to:
scale the first similarity metric and the second similarity metric based on a number of a set of models being used, including the first model and the second model; and
apply a softmax function over the set of models to determine gate activation probabilities for routing the input vector to each model of the set of models.

7. The computer program product of claim 1, wherein the instructions are further configured to cause the at least one computing device to:
determine the first similarity metric and the second similarity metric using an affinity matrix.

8. The computer program product of claim 1, wherein the instructions are further configured to cause the at least one computing device to:
determine a third similarity metric between the input vector and a third routing vector associated with a third model; and
route the input vector to the first model, based on the first similarity metric, the second similarity metric, and the third similarity metric.

9. The computer program product of claim 8, wherein the instructions are further configured to cause the at least one computing device to:
route the input vector to the first model and to the second model, based on the first similarity metric, the second similarity metric, and the third similarity metric.

10. The computer program product of claim 1, wherein the first model and the second model are domain-trained models constructed using a large language model having a generative pre-trained transformer.

11. A computer-implemented method, the method comprising:
receiving an input vector;
determining a first similarity metric between the input vector and a first routing vector associated with a first model;
determining a second similarity metric between the input vector and a second routing vector associated with a second model; and
routing the input vector to the first model, based on the first similarity metric and the second similarity metric.

12. The method of claim 11, further comprising:
receiving an input; and
embedding the input within a vector space that is common to the first routing vector and the second routing vector to obtain the input vector.

13. The method of claim 11, further comprising:
determining a first cosine similarity as the first similarity metric; and
determining a second cosine similarity as the second similarity metric.

14. The method of claim 11, further comprising:
training the first routing vector using at least a subset of a training dataset used to train the first model, and using a loss function used to train the first model.

15. The method of claim 11, further comprising:
scaling the first similarity metric and the second similarity metric based on a number of a set of models being used, including the first model and the second model; and
applying a softmax function over the set of models to determine gate activation probabilities for routing the input vector to each model of the set of models.

16. The method of claim 11, further comprising:
determining a third similarity metric between the input vector and a third routing vector associated with a third model;
routing the input vector to the first model, based on the first similarity metric, the second similarity metric, and the third similarity metric; and
routing the input vector to the first model and to the second model, based on the first similarity metric, the second similarity metric, and the third similarity metric.

17. A system comprising:
at least one memory including instructions; and
at least one processor that is operably coupled to the at least one memory and that is arranged and configured to execute instructions that, when executed, cause the at least one processor to:
receive an input vector;
determine a first similarity metric between the input vector and a first routing vector associated with a first model;
determine a second similarity metric between the input vector and a second routing vector associated with a second model; and
route the input vector to the first model, based on the first similarity metric and the second similarity metric.

18. The system of claim 17, wherein the instructions are further configured to cause the at least one processor to:
receive an input; and
embed the input within a vector space that is common to the first routing vector and the second routing vector to obtain the input vector.

19. The system of claim 17, wherein the instructions are further configured to cause the at least one processor to:
determine a first cosine similarity as the first similarity metric; and
determine a second cosine similarity as the second similarity metric.

20. The system of claim 17, wherein the instructions are further configured to cause the at least one processor to:
train the first routing vector using at least a subset of a training dataset used to train the first model, and using a loss function used to train the first model.
